(19) United States
(12) Patent Application Publication
(10) Pub. No.: US 2014/0076628 A1
(43) Pub. Date: Mar. 20, 2014

(54) RIGIDIFIED NON-CONDUITED ELECTRICAL HARNESSES

(71) Applicant: ICORE INTERNATIONAL, INC., Santa Rosa, CA (US)

(72) Inventors: Mark McGrath, Santa Rosa, CA (US); Gregory S. Baeder, Guerneville, CA (US); Scott M. Andrews, Santa Rosa, CA (US)

(73) Assignee: ICORE INTERNATIONAL, INC., Santa Rosa, CA (US)

(21) Appl. No.: 13/794,346

(22) Filed: Mar. 11, 2013

Related U.S. Application Data
(60) Provisional application No. 61/703,728, filed on Sep. 20, 2012.

(51) Int. Cl. H01B 7/00

(52) U.S. Cl. CPC H01B 7/0045
USPC 174/84 R; 174/110 R; 174/124 R

(57) ABSTRACT

A rigidified flexible cable including flexible portions and one or more rigid segments, including a primary flexible cable with ends and end fittings, and at least one rigid medial section integral with the flexible portion and formed by coating the flexible cable material with a composite matrix material. Lateral transitions can be incorporated into the cable run and customized to the installation site specifications.

### CROSS REFERENCES TO RELATED APPLICATIONS

The present application claims the benefit of U.S. Provisional Patent Application Ser. No. 61/703,728, filed Sep. 20, 2012 (Sep. 20, 2012).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

1. Field of the Invention

Field of the Invention: The present invention relates most generally to electrical cables, and more particularly to an assembly consisting of a flexible cable with two or more end fittings, one or more multiple leg transitions, and at least one intermediate rigid section, wherein the rigid section is formed around the flexible cable using a fiber reinforced polymeric composite material, thereby eliminating the need for additional fittings for the flexible/rigid portion junctions.

2. Background Discussion

To achieve maximum flight safety and economy, when providing components for aircraft, aerospace manufacturers strive to make components that strike a fine balance between structural integrity and minimal weight while not compromising performance in any way. For instance, it is well known in the art that electrical signal transmission lines for navigation, radar, and in-flight computer controlled systems critical to flight safety must be protected from other nearby lines and more generally from ambient electromagnetic interference (EMI) and radio frequency interference (RFI). Accordingly, aerospace wiring cables used to house and protect electrical cables and wires for aeronautical applications and avionics traditionally utilized heavy tin-plated copper metal overbraid. Over time, to save on weight, conduit jacketed with wraparound metal foils or metalized fabrics were eventually developed. Further, lightweight solutions are constantly being developed. Electrical wiring for aerospace assemblies must be configured and conformed to fit in tight spaces and must be protected from vibrations or other forces that could degrade or disrupt performance. In some instances cables can run virtually the entire length of the aircraft. But even short runs of cable can include multiple bends. Thus, when employing flexible cable, where rigid sections are called for, the rigid sections are typically provided by terminating a flexible portion with a fitting, coupling it to a first end of a rigid (typically metal) portion having a complementary fitting, and then coupling a fitting on the second end of the rigid portion to another section of flexible cable having a complementary fitting, or utilizing a heat-shrink boot, and so on for as many rigid bends as required under the circumstances. By way of example, if a complete cable assembly requires three flexible sections and two rigid sections, there are a total of four junctions between the sections that require a total of ten fittings, ten heat shrink sleeves, or five boots. Those fittings are generally welded onto the rigid sections and swaged onto the flexible sections, or if heat shrink sleeves or boots are used, they must be applied and sealed to the cable assembly. The fabrication costs can be quite high, as the fittings, sleeves, or boots themselves must be provided, attached to the cable sections, and then assembled. And the weight increase is substantial. Furthermore, each juncture presents an increased risk of failure.

### BRIEF SUMMARY OF THE INVENTION

The present invention provides a novel method for creating a continuous system of flexible electrical harness having one or more rigidified sections. Composite bends, end fittings, the medial sections and multiple leg transitions, as required, are incorporated into a unified whole by using a composite matrix material to coat the harness at the ends, the medial section, or anywhere the rigidifying is required. Brackets can also be incorporated into the rigidified portions of the harness. This assembly entirely obviates the need for multiple fittings. This results in reduced manufacturing costs, reduces overall apparatus weight, and substantially reduces the risk of failure.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a top plan schematic view of a preferred embodiment of the rigidified flexible cable of the present invention.

### DETAILED DESCRIPTION OF THE INVENTION

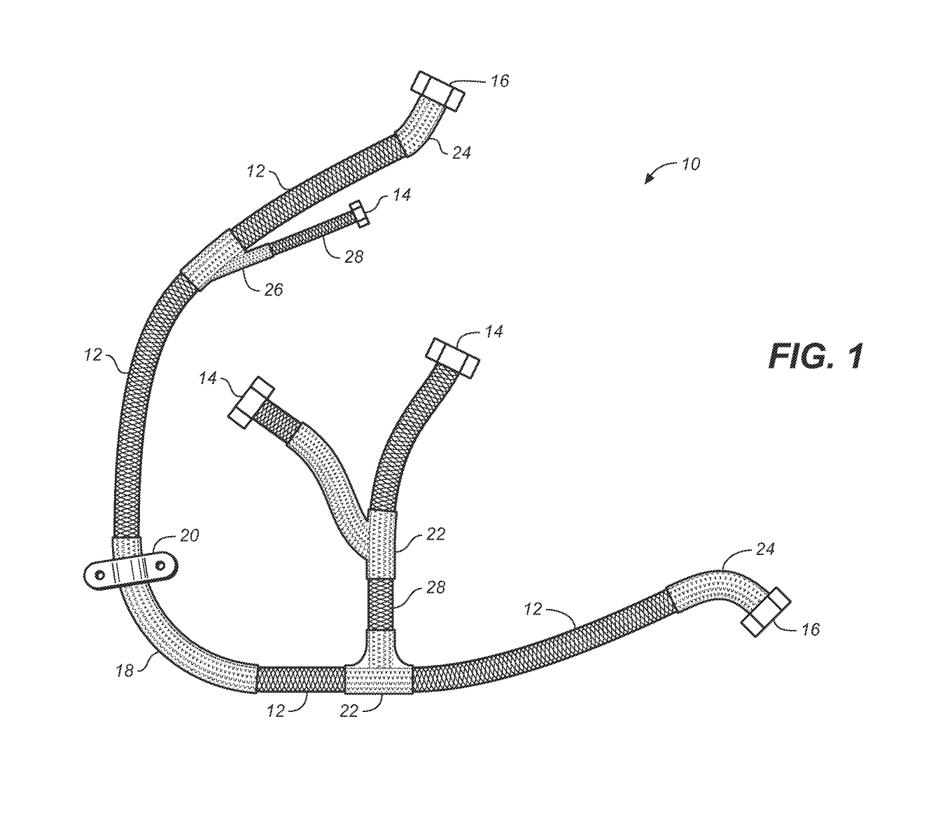

Referring to FIG. 1, the present invention 10 provides a novel means to rigidify a run of cable or harness in virtually any configuration without the expense and complexity of having to provide multiple fittings and junctions or the need to bend marginally bendable conduit in multiple dimensions. For any given run of cable, the inventive apparatus comprises a length of flexible cable 12 having two, or more, end connectors or fittings 14, 16. In the illustration, the cable is agnostic (of indeterminate type). The structural elements include single or multiple conductor wires and/or coaxial, or multiple conductor cables, and the cable and wires may be shielded with one or two layers of braided metal wire shielding made from stainless steel or copper plated with tin or nickel, and may be covered with a jacket of rubber, elastomer, or heat shrink material. Also, overbraiding may be provided by a durable fabric, such as Dacron® (Dacron is a registered trademark of E. I. Du Pont De Nemours and Company Corporation of Wilmington, Del.), or other fabric, aviation grade approved. The fittings shown are also agnostic and schematically show that the fittings could comprise a wide variety of termination types. The medial rigid section 18, the rigid end sections 24, and any multiple leg transitions 22, are formed by the application of a composite matrix material, preferably a polymer matrix material reinforced with various materials, such as s-glass fibers, carbon fiber, aramid, and the like, perhaps even including paper, wood, or asbestos, summarily identified as a fiber-reinforced polymer (FRP). Iin this instance, only one rigid medial section 18 is shown, and the multiple leg transitions shown 22 include only three legs or branches. However, it will be appreciated that the number of both medial rigid sections and transitions on the primary cable at lateral branches is essentially unlimited, depending only on the length of the cable run and the size of the rigidified portions. Brackets 20 for attaching the cable to airframe structures may be incorporated or integrated into the composite material section or placed over the rigid section at the time of installation.

Composite bends 24 can also be (though need not be) provided at the cable ends immediately proximate the end fittings. Multiple leg transitions 22 can connect lateral branches 28 of flexible cable with the main flexible cable 12, and they can be formed in any of a number of conventional shapes, such as Ts and EIs, with generally normal branch angles, or Ys and Vs with low crotch angles 26. In this manner a system of flexible cables having rigidified sections can be provided. Such an assembly is both structurally robust in select segments to withstand forces that tend to damage cable runs at those locations, but it is also flexible in other segments so as to facilitate placement, fitting, and installation. The apparatus eliminates entirely the need for multiple and separable fittings, thereby reducing manufacturing costs, overall apparatus weight, and risk of apparatus failure.

Fabrication of the rigidified cable can be completed in the field manually by a skilled installer through hand or wet layup or by wrapping of the bare cable in situ, though it is more advantageously finished as a custom article in the factory after careful measurements are taken of the installation run. However, because large segments of the cable can be left free of the rigidifying material, there remains a significant amount of latitude in the placement and installation procedure.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A rigidified flexible electrical cable or harness having a predetermined configuration and length, comprising:
a primary flexible cable having a first end and a second end;
end connectors disposed at each of said first and second ends; and
at least one rigid medial section disposed in said primary flexible cable or harness and a coating of a composite matrix material.

2. The apparatus of claim 1, wherein said composite matrix material is a polymer matrix material reinforced with fibers selected from the group consisting of s-glass fibers, carbon fiber, aramid.

3. The apparatus of claim 1, wherein said cable or harness consists of single or multiple conductor wires and/or coaxial, or multiple conductor cables.

4. The apparatus of claim 3, further including at least one layer of braided metal wire shielding made from stainless steel or copper plated with tin or nickel

5. The apparatus of claim 3, further including overbraiding fabricated from a durable synthetic fibers.

6. The apparatus of claim 5, wherein said durable synthetic fibers comprise polyethylene terephthalate.

7. The apparatus of claim 1, wherein said fittings are electrical wiring fittings.

8. The apparatus of claim 1, further including at least one bracket for attaching said conduit to a substrate, said bracket integrated into said at least one rigid medial section using said composite matrix material.

9. The apparatus of claim 1, wherein at least one of said first and said second end includes a composite bend immediately proximate its respective end fitting.

10. The apparatus of claim 1, further including at least one multiple leg transition connecting lateral branch cables or harnesses to said primary flexible cable or harness.

11. A run of rigidified flexible cable, comprising:
at least one primary flexible cable having a first end and a second end;
connector fittings disposed at each of said first and second ends; and
at least one rigid medial section disposed in said primary flexible cable, said rigid medial section coated with a composite matrix material.

12. The apparatus of claim 11, further including wherein said composite matrix material is a fiber reinforced polymer.

13. The apparatus of claim 12, further including at least one layer of braided metal wire shielding made from stainless steel or copper plated with tin or nickel

14. The apparatus of claim 11, further including at least one attachment bracket integrated into said at least one rigid medial section using said composite matrix material.

15. The apparatus of claim 11, wherein at least one of said first and said second end includes a composite matrix material bend immediately proximate its respective end fitting.

16. The apparatus of claim 11, further including at least one multiple leg transition connecting a lateral branch of at least one cable to said primary flexible cable.

17. The apparatus of claim 16, wherein said at least one multiple leg transition is a rigidified junction of said primary cable branching into at least one lateral cable segment, said rigidified junction formed of composite matrix material coating flexible cable.

18. The apparatus of claim 17, including a plurality of multiple leg transitions disposed on said primary cable.

19. A combination flexible and rigid cable, comprising:
At least one flexible portion of cable;
At least one rigid portion of cable, wherein said rigid portion includes flexible cable integral with said flexible portion and coated with a hard polymer.

20. The apparatus of claim 19, wherein said hard polymer is a fiber reinforced polymer.
